(19) United States
(12) Patent Application Publication
(10) Pub. No.: US 2013/0155183 A1
(43) Pub. Date: Jun. 20, 2013

(54) MULTI IMAGE SUPPLY SYSTEM AND MULTI IMAGE INPUT DEVICE THEREOF

(71) Applicants: Byoung-Jun PARK, Iksan-si (KR); Sang Hyeob Kim, Daejeon (KR); Eun Hye Jang, Daejeon (KR); Myung-Ae Chung, Daejeon (KR)

(72) Inventors: Byoung-Jun PARK, Iksan-si (KR); Sang Hyeob Kim, Daejeon (KR); Eun Hye Jang, Daejeon (KR); Myung-Ae Chung, Daejeon (KR)

(73) Assignee: Electronics and Telecommunications Research Institute, Daejeon (KR)

(21) Appl. No.: 13/620,627

(22) Filed: Sep. 14, 2012

(30) Foreign Application Priority Data
Dec. 14, 2011 (KR) 10-2011-0134830

(51) Int. Cl. H04N 7/00

(52) U.S. Cl. 348/38; 348/E07.001

(57) ABSTRACT

The inventive concept relates to a multi image supply system and a multi image input device thereof. The multi image input device includes a plurality of cameras, and the plurality of cameras shoots the plurality of images so that a horizontal viewing angle of the synthesized image is 120°˜180° and a vertical viewing angle of the synthesized image is 60°˜180°. According to the inventive concept, the multi image supply system obtains a multi image having no blind spots with respect to the front view using a plurality of cameras and synthesizes the obtained multi image. Thus, the multi image supply system can display an image having no blind spots with respect to the front view to a user.

### CROSS-REFERENCE TO RELATED APPLICATIONS

This U.S. non-provisional patent application claims priority under 35 U.S.C. §119 of Korean Patent Application No. 10-2011-0134830, filed on Dec. 14, 2011, the entire contents of which are hereby incorporated by reference.

### BACKGROUND

The present inventive concept herein relates to multi image supply systems and multi image input devices thereof.

A person obtains sense information of about 80%˜90% from a sight. Thus, processing information (hereinafter image information) obtained through a sight is the most important function in a survival of human and a mental activity of human. A study of technology of obtaining image information from the outside using a camera and then processing the obtained image information is actively proceeding.

In the front viewing angle of human, a horizontal field of vision is 60° with respect to right and left directions respectively and a vertical field of vision is 30° with respect to up and down respectively. Thus, a person has a region (hereinafter it is referred to as a blind spot) that cannot obtain image information with respect to the front view. Thus, a requirement for a technology that can obtain image information while not having a blind spot with respect to the front view is being increased. However, a conventional camera has a small viewing angle as compared with human view.

### SUMMARY

Embodiments of the inventive concept provide a multi image input device. The multi image input device may include a plurality of cameras; and a body fitted with the plurality of cameras. The plurality of cameras is built on the body so that the cameras have a horizontal viewing angle of 120°˜180° and a vertical viewing angle of 60°˜180° with respect to the front view of body.

Embodiments of the inventive concept also provide a multi image supply system. The multi image supply system may include a multi image input device obtaining a plurality of images from a plurality of cameras; a multi image processing device synthesizing the plurality of images obtained from the multi image input device; and a display device providing images synthesized in the multi image processing device to a user. The multi image input device includes a plurality of cameras, and the plurality of cameras shoots the plurality of images so that a horizontal viewing angle of the synthesized image is 120°˜180° and a vertical viewing angle of the synthesized image is 60°˜180°.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a block diagram illustrating a multi image supply system in accordance with some embodiments of the inventive concept.

FIG. 2 is a flow chart showing an operation of the multi image supply system of FIG. 1.

FIGS. 3 and 4 are drawings illustrating an embodiment of multi image input device of FIG. 1.

FIG. 5 is a drawing for explaining a multi image processing device of FIG. 1.

FIG. 6 is a drawing illustrating a camera distortion correction part of FIG. 5 in more detail.

FIG. 7 is a drawing illustrating an image conversion matrix generation part of FIG. 5 in more detail.

FIG. 8 is a drawing illustrating an embodiment of operation of the image conversion matrix generation part illustrated in FIG. 7.

FIG. 9 is a drawing for explaining a real time image processing part of FIG. 5 in more detail.

FIGS. 10 and 11 are flow charts showing an operation of preprocessing part of FIG. 5.

FIG. 12 is a flow chart showing an operation of real time image processing part of FIG. 5.

FIG. 13 is a block diagram illustrating a multi image supply system in accordance with some other embodiments of the inventive concept.

FIG. 14 is a drawing illustrating an embodiment of operation of the multi image supply system of FIG. 1.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

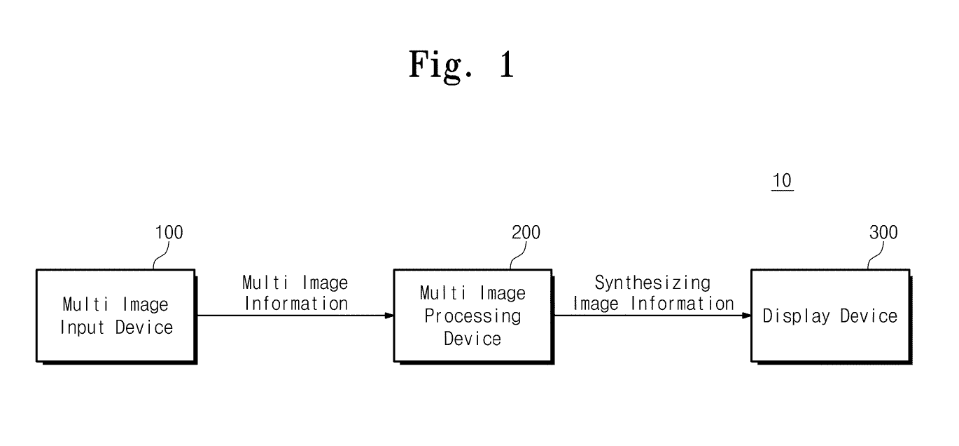

FIG. 1 is a block diagram illustrating a multi image supply system 10 in accordance with some embodiments of the inventive concept. The multi image supply system 10 obtains a multi image not having a blind point with respect to a front viewing angle using a plurality of cameras and provides a synthesized multi image to a user. Referring to FIG. 1, the multi image supply system 10 includes a multi image input device 100, a multi image processing device 200 and a display device 300.

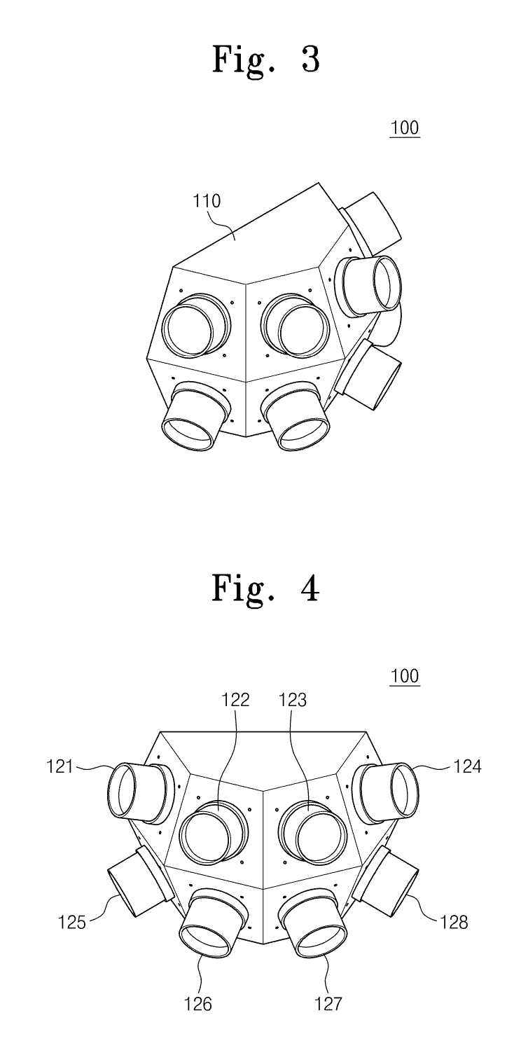

The multi image input device 100 includes a plurality of cameras and shoots a plurality of images using the plurality of cameras. The multi image input device 100 is fitted with the plurality of cameras so that the plurality of synthesized images does not have a blind spot with respect to the front view. Images shot by the plurality of cameras of multi image input device 100 are synchronized in real time by a synchronizing signal. Information about a plurality of synchronized images (hereinafter it is referred to as multi image) is provided to the multi image processing device 200 through a wireless or wire transmission path. The multi image input device 100 will be described in more detail in FIGS. 3 and 4.

The multi image processing device 200 is supplied to information about the multi image (hereinafter it is referred to as multi image information) from the multi image input device 100. The multi image processing device 200 may receive multi image information through wireless network or cable.

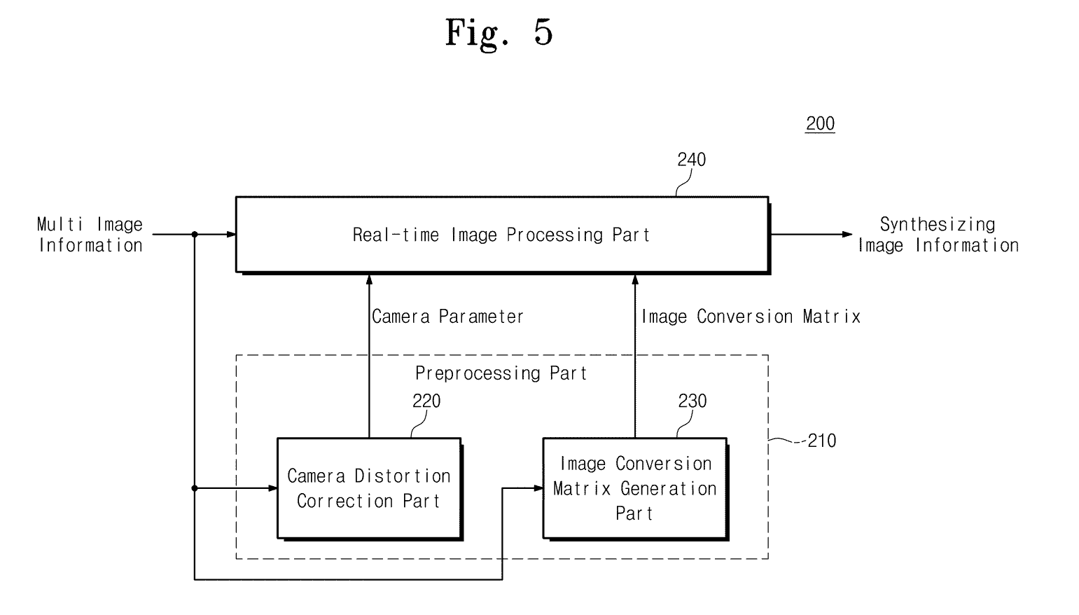

The multi image processing device 200 synthesizes a multi image in real time through an image change matrix generation operation, a camera parameter generation operation, a distortion correction operation, a stitching operation, a blending operation, etc. and provides information about the synthesized multi image (hereinafter it is referred to as synthesized image information) to the display device 300. The multi image processing device 200 will be described in FIGS. 5 through 12 in detail.

The display device 300 receives synthesized image information and provides the synthesized image to a user in real time. In this case, the synthesized image provided to a user through the display device 300 is an image having no blind spots with respect to the front view.

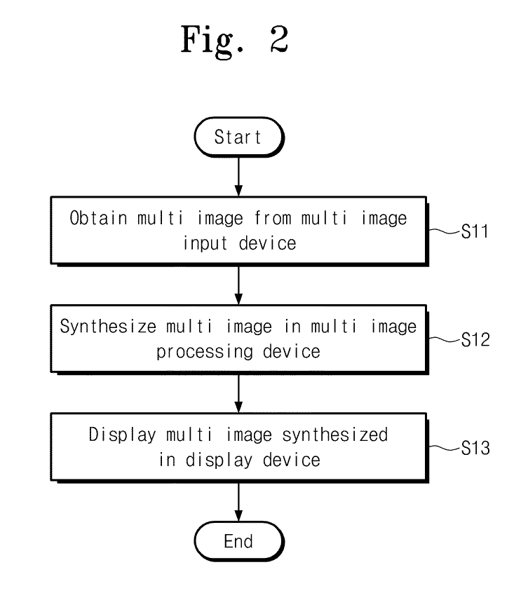

FIG. 2 is a flow chart showing an operation of the multi image supply system 10 of FIG. 1.

In S11, a multi image input device 100 shoots a plurality of images. In this case, the multi image input device 100 is configured to shoot a plurality of images having no blind spots with respect to the front view. The plurality of images is synchronized in real time by a synchronizing signal and information about the synchronized images is provided to the multi image processing device 200. In S12, the multi image processing device 200 synthesizes the synchronized images in real time. In S13, the display device 300 provides the synthesized images to a user in real time.

As described in FIGS. 1 and 2, the multi image supply system 10 obtains multi images having no blind spots with respect to the front view using a plurality of cameras and synthesizes the obtained multi image in real time. Thus, the multi image supply system can display multi images having no blind spots with respect to the front view to a user.

FIGS. 3 and 4 are drawings illustrating an embodiment of multi image input device 100 of FIG. 1. The multi image input device 100 is designed by imitating eyes of human and eyes of insect.

Referring to FIGS. 3 and 4, the multi image input device 100 includes a body 110 and a plurality of cameras 121 through 128. The plurality of cameras 121 through 128 may be a miniature camera having a CMOS or CCD image sensor. The plurality of cameras 121 through 128 is properly disposed on the body not to have blind spots with respect to the front view.

The plurality of cameras 121 through 128 may be disposed to have a horizontal viewing angle of 180° or more and a vertical viewing angle of 70° or more. Since a viewing angle of human is 120° in a horizontal direction and 60° in a vertical direction, the plurality of cameras 121 through 128 may be disposed to have a viewing angle greater than the viewing angle of human. The plurality of cameras 121 through 128 may be disposed so that a horizontal viewing angle is 120°˜180° and a vertical viewing angle is 60°˜180°.

A plurality of images shot by the plurality of cameras 121 through 128 are synchronized with each other in real time. The synchronized images (i.e., synchronized multi image) are provided to the multi image processing device 200. In FIGS. 3 and 4, the multi image input device 100 includes 8 cameras. This is only an illustration and a technical spirit of the inventive concept is not limited thereto.

FIG. 5 is a drawing for explaining a multi image processing device 200 of FIG. 1. Referring to FIG. 5, the multi image processing device 200 includes a preprocessing part 210 and a real-time image processing part 240.

The preprocessing part 210 receives multi image information from the multi image input device 100 and performs a preprocessing operation thereon.

The preprocessing part 210 includes a camera distortion correction part 220 and an image conversion matrix generation part 230.

The camera distortion correction part 220 receives multi image information and generates camera parameters using the multi image information. The camera parameter means a distortion coefficient correcting a difference in lens distortion of camera and external parameters for rotation and movement between coordinate system. The camera distortion correction part 220 provides a camera parameter generated during the preprocessing operation to the real-time image processing part 240.

The image conversion matrix generation part 230 receives multi image information and generates an image conversion matrix using the multi image information. The image conversion matrix generation part 230 generates an image conversion matrix to synthesize a multi image through an extraction operation of feature and a matching operation with respect to a multi image. The image conversion matrix generation part 230 provides an image conversion matrix generated during the preprocessing operation to the real-time image processing part 240.

The real-time image processing part 240 receives multi image information, a camera parameter and an image conversion matrix from the multi image input device 100, the camera distortion correction part 220 and the image conversion matrix generation part 230 respectively. The real-time image processing part 240 corrects a multi image being received in real time using the camera parameter and synthesizes the corrected multi image using the image conversion matrix. The real-time image processing part 240 provides information about the synthesized multi image to the display part 300.

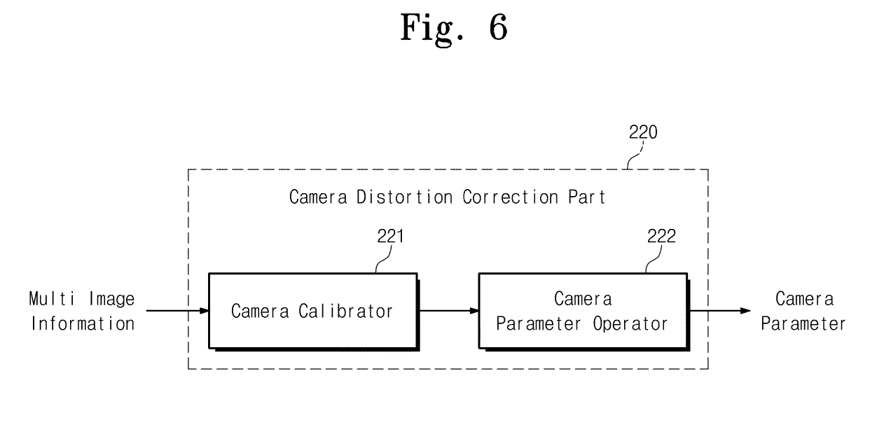

FIG. 6 is a drawing illustrating a camera distortion correction part 220 of FIG. 5 in more detail. Referring to FIG. 6, the camera distortion correction part 220 includes a camera calibrator 221 and a camera parameter operator 222.

The camera calibrator 221 receives multi image information from the multi image input device 100 and performs a camera calibration operation interpreting properties of the cameras of the multi image input device 100 by a mathematical model using the multi image information. The camera calibrator 221 may use a corner point and blob detection technology to extract an accurate point from an image of cross stripes or an image of circle pattern. The camera calibrator 221 can find properties of the cameras from relation between the obtained multi image information and a real three-dimensional space.

The camera parameter operator 222 receives information about a result of camera calibration operation from the camera calibrator 221 and calculates a camera parameter using the information. The camera parameter operator 222 can calculate a distortion coefficient correcting a difference in lens distortion of camera and/or a camera parameter like an external parameter for rotation and movement between coordinate system.

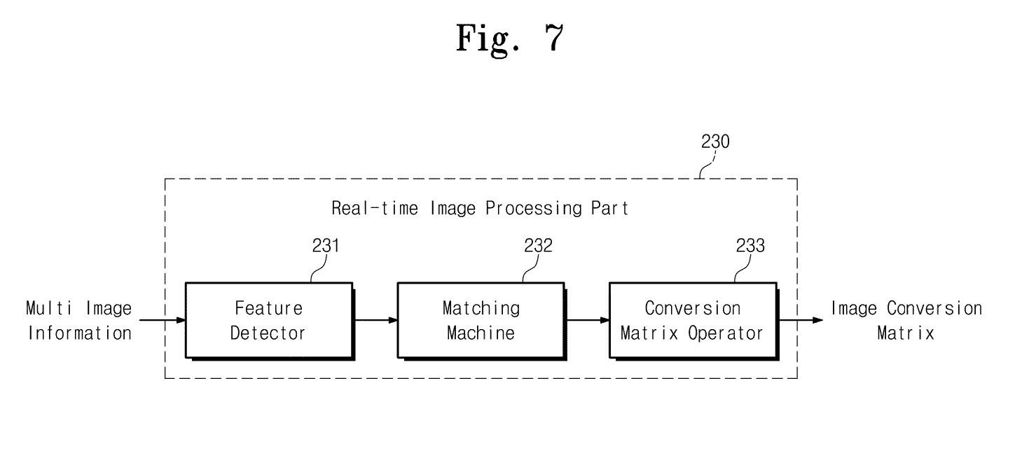

FIG. 7 is a drawing illustrating an image conversion matrix generation part 230 of FIG. 5 in more detail. Referring to FIG. 7, the image conversion matrix generation part 230 includes a feature detector 231, a matching machine 232 and a conversion matrix operator 233.

The feature detector 231 receives multi image information from the multi image input device 100 and detects features of a plurality of images. The feature detector 231 detects features of a plurality of images using an algorism such as a scale invariant feature transform (SIFT).

The matching machine 232 receives information about features detected in the feature detector 231 and finds a feature cluster using the information. The matching machine 232 finds a matched key point cluster (i.e., a feature cluster) using a nearest-neighbor search and a hough transformation.

The conversion matrix operator 233 receives information about a feature cluster from the matching machine 232 and generates an image conversion matrix using the information. The conversion matrix operator 233 generates the optimum image conversion matrix among feature clusters using a RANdom sample consensus (RANSAC) algorism and a homography matrix method.

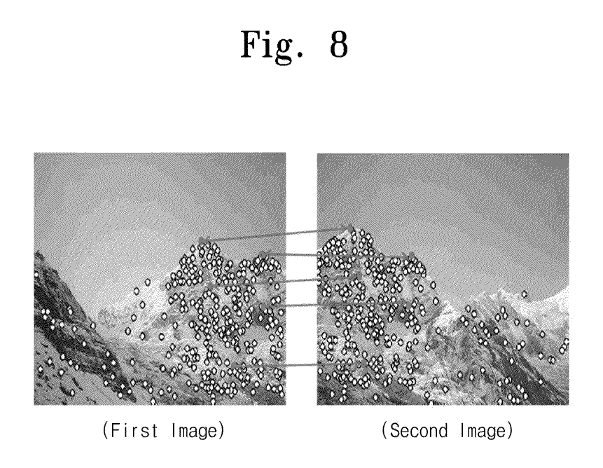

FIG. 8 is a drawing illustrating an embodiment of operation of the image conversion matrix generation part 230 illustrated in FIG. 7. Referring to FIGS. 7 and 8, the feature detector 231 extracts features of first and second images, the matching machine 232 matches features and the conversion matrix operator 233 can generate an image conversion matrix using a matching result.

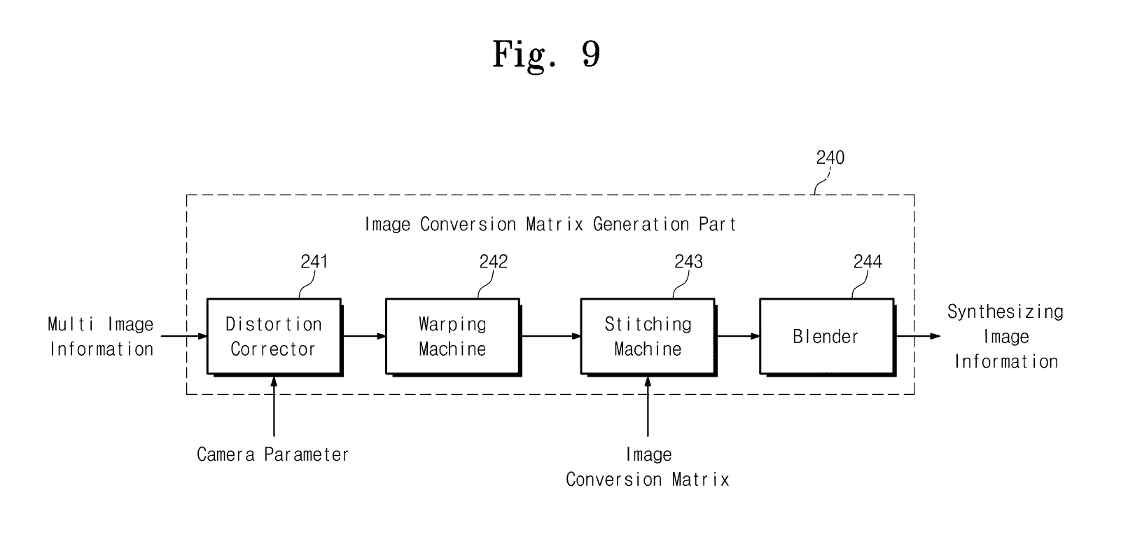

FIG. 9 is a drawing for explaining a real time image processing part 240 of FIG. 5 in more detail. Referring to FIG. 9, the real-time image processing part 240 includes a distortion corrector 241, a warping machine 242, a stitching machine 243 and a blender 244.

The distortion corrector 241 receives multi image information from the multi input device 100 and receives a camera parameter from the camera distortion correction part 220. The distortion corrector 241 performs a correction operation on a multi image being received in real time using the camera parameter.

The warping machine 242 receives the corrected multi image from the distortion corrector 241 and performs a warping operation on the corrected multi image. The warping machine performs is an operation of projecting multi images onto a cylinder using a camera focal distance that can be obtain through the camera calibrator 221 during a preprocessing operation.

The stitching machine 243 receives information about warped multi image from the warping machine 242 and receives an image conversion matrix from the image conversion matrix generation part 230. The stitching machine 243 performs a stitching operation on the warped multi image using the image conversion matrix. That is, stitching machine 243 performs an operation of naturally putting a plurality of images partly overlap with each other together using the image conversion matrix. The stitching machine 243 can perform a stitching operation using a direct alignment scheme and a feature based alignment scheme.

The blender 244 receives a stitched image from the stitching machine 243. Since an image stitched by the stitching machine 243 has a different light and shade at every between images, sense of difference exists at an area where images cross each other. Thus, the blender 244 performs a blending process and a color correction operation to remove the sense of difference. The blender 244 provides images (i.e., synthesized image) on which a blending process and a color correction are performed to the display device 300.

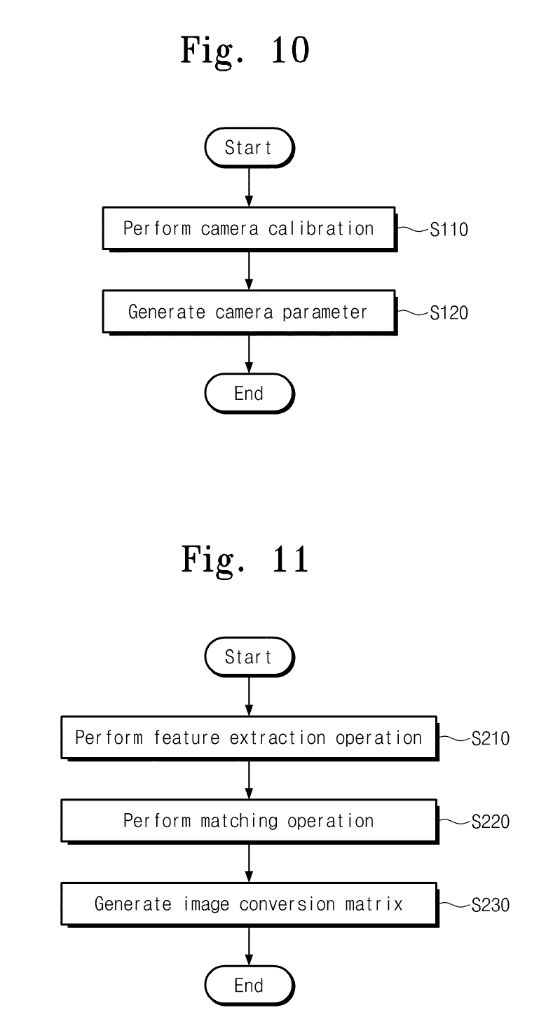

FIGS. 10 and 11 are flow charts showing an operation of preprocessing part 210 of FIG. 5.

Referring to FIG. 10, an operation of generating a camera parameter by the camera distortion correction part 220 of FIG. 5 is described. In S110, the camera calibrator 221 performs a camera calibration on a multi image. In 5120, the camera parameter operator 222 receives information about a result of camera calibration from the camera calibrator 221 and calculates a camera parameter using the information.

Referring to FIG. 11, an operation is described that an image conversion matrix is generated by the image conversion matrix generation part 230 of FIG. 5. In 5210, the feature detector 231 extracts features of multi image. In S220, the matching machine 232 performs a matching operation on the features of multi image. In 5230, the conversion matrix operator 233 generates an image conversion matrix on the basis of a matching result.

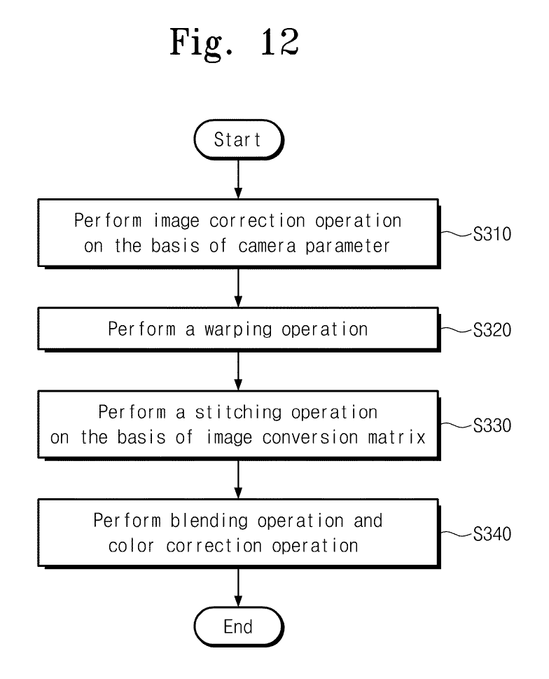

FIG. 12 is a flow chart showing an operation of real time image processing part of FIG. 5.

In S310, the distortion corrector 241 receives a camera parameter obtained during the preprocessing operation and performs a distortion correction operation on a multi image using the camera parameter. In S320, the warping machine 242 performs a warping operation of projecting the corrected multi image onto a cylinder. In S330, the stitching machine 243 performs a stitching operation of connecting multi images which partly overlaps with each other using the image conversion matrix obtained during the preprocessing operation. In S340, the blender 244 performs a blending process and a color correction operation to remove a sense of difference of connected image.

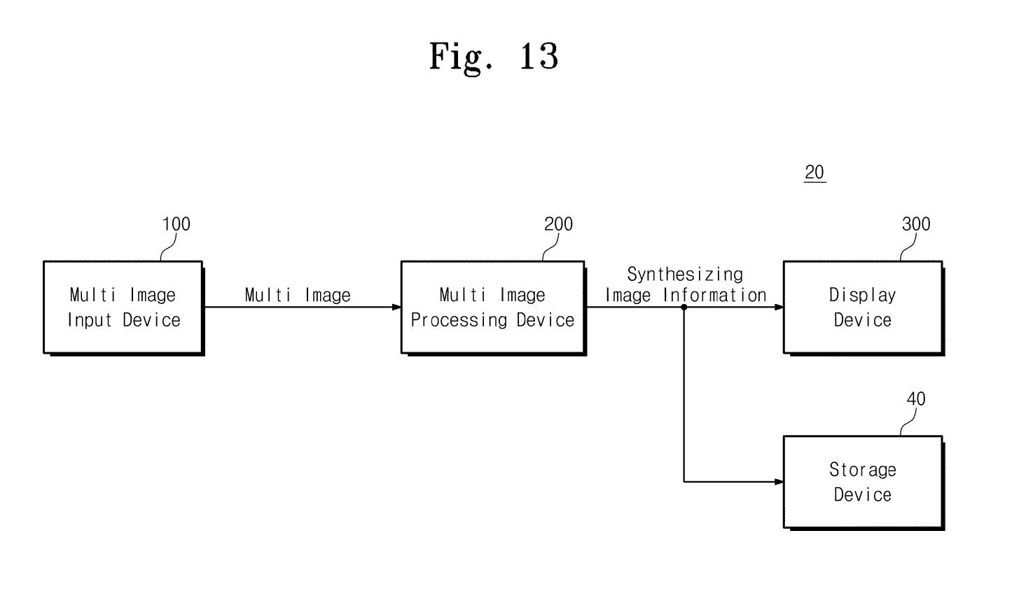

FIG. 13 is a block diagram illustrating a multi image supply system 20 in accordance with some other embodiments of the inventive concept. The multi image supply system 20 of FIG. 13 further includes a storage device 400 as compared with the multi image supply system 10 of FIG. 1. That is, when a multi image is synthesized in real time by the multi image processing device 200, the multi image supply system 20 of FIG. 13 displays a synthesized image being generated in real time to a user through the display device 300 and can store the synthesized image in the storage device 400 at the same time.

As described above, the multi image supply system in accordance with some embodiments of the inventive concept obtains a multi image having no blind spots with respect to the front view using a plurality of cameras and can synthesize the obtained multi image in real time. The multi image supply system can display a synthesized image having no blind spots with respect to the front view to a user in real time.

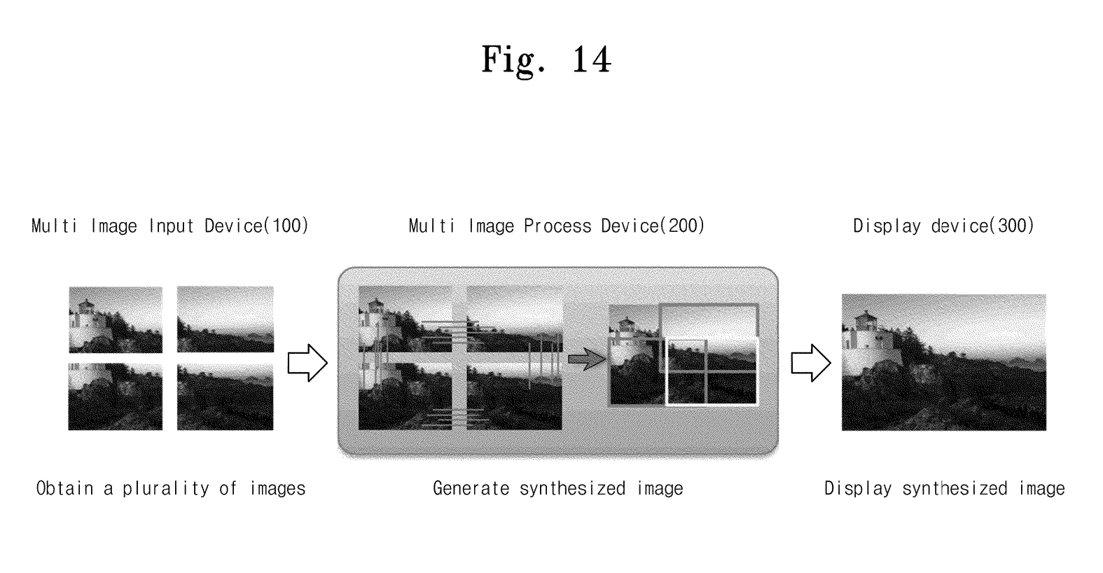

FIG. 14 is a drawing illustrating an embodiment of operation of the multi image supply system 10 of FIG. 1.

As illustrated in FIG. 14, a plurality of images having no blind spots with respect to the front view is obtained by the multi image input device 100. The multi image processing device 200 performs a synthesizing operation on the plurality of images and thereby generates a synthesized image in real time. The display device 300 displays the generated synthesized image in real time.

According to some embodiments of the inventive concept, the multi image supply system obtains a multi image having no blind spots with respect to the front view using a plurality of cameras and synthesizes the obtained multi image. Thus, the multi image supply system can display an image having no blind spots with respect to the front view to a user.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A multi image input device comprising:
a plurality of cameras; and
a body fitted with the plurality of cameras,
wherein the plurality of cameras is built on the body so that the cameras have a horizontal viewing angle of 120°˜180° with respect to a front view of the body and a vertical viewing angle of 60°˜180° with respect to the front view of the body.

2. The multi image input device of claim 1, wherein images shot by the plurality of cameras are synchronized in real time.

3. A multi image supply system comprising:
a multi image input device obtaining a plurality of images from a plurality of cameras;
a multi image processing device synthesizing the plurality of images obtained from the multi image input device; and
a display device providing images synthesized in the multi image processing device to a user,
wherein the multi image input device includes a plurality of cameras, and the plurality of cameras shoots the plurality of images so that a horizontal viewing angle of the synthesized image is 120°˜180° and a vertical viewing angle of the synthesized image is 60°˜180°.

4. The multi image supply system of claim 3, wherein the multi image processing device comprises:
a preprocessing part generating a camera parameter and an image conversion matrix; and
a real-time image processing part synthesizing the plurality of images in real time using the camera parameter and the image conversion matrix.

5. The multi image supply system of claim 4, wherein the preprocessing part comprises:
a camera distortion calibrator generating the camera parameter to calibrate a difference in a lens distortion of the cameras; and
an image conversion matrix generation part generating the image conversion matrix on the basis of features of the images.

6. The multi image supply system of claim 5, wherein the image conversion matrix generation part comprises:
a feature detector detecting features of the plurality of images;
a matching machine matching features detected from the feature detector; and
a conversion matrix operator generating the image conversion matrix on the basis of a matching result of the matching machine.

7. The multi image supply system of claim 6, wherein the feature detector detects features of the plurality of images using a SIFT algorithm.

8. The multi image supply system of claim 6, wherein the matching machine matches features detected from the feature detector using a nearest-neighbor search scheme or a hough transformation scheme.

9. The multi image supply system of claim 6, wherein the conversion matrix operator generates the image conversion matrix using a RAMSAC algorithm or a homography matrix scheme.

10. The multi image supply system of claim 4, wherein the real-time image processing part comprises a distortion corrector performing a correction operation on the plurality of images.

11. The multi image supply system of claim 10, wherein the real-time image processing part further comprises a warping machine projecting the plurality images corrected by the distortion corrector onto a cylinder.

12. The multi image supply system of claim 11, wherein the real-time image processing part further comprises a stitching machine performing a stitching operation connecting the plurality of images projected onto the cylinder by the warping machine.

13. The multi image supply system of claim 12, wherein the real-time image processing part further comprises a blender performing a blending processing or a color correction on the images stitched by the stitching machine.

14. The multi image supply system of claim 3, wherein images shot by the plurality of cameras are synchronized in real time.

15. The multi image supply system of claim 3, further comprising a storage device storing images synthesized in the multi image processing device.
